(19) United States
(12) Patent Application Publication
(10) Pub. No.: US 2025/0167503 A1
(43) Pub. Date: May 22, 2025

(54) Terminal Strip Splicing Device and Terminal Strip Splicing Method

(71) Applicants: Tyco Electronics (Zhuhai) Ltd, Zhuhai (CN); TE Connectivity Solutions GmbH, Schaffhausen (CH); Tyco Electronics (Shanghai) Co., Ltd., Shanghai (CN)

(72) Inventors: Lei (Alex) Zhou, Shanghai (CN); Wei Zheng, Zhuhai (CN); Dandan (Emily) Zhang, Shanghai (CN); Roberto Francisco-Yi Lu, Bellevue, WA (US); Jianhong Ouyang, Zhuhai (CN); Ming (Micky) Jiang, Zhuhai (CN); Liqing (Mary) Ma, Zhuhai (CN)

(73) Assignees: Tyco Electronics (Zhuhai) Ltd, Zhuhai (CN); TE Connectivity Solutions GmbH, Schaffhausen (CH); Tyco Electronics (Shanghai) Co., Ltd., Shanghai (CN)

(21) Appl. No.: 18/956,299

(22) Filed: Nov. 22, 2024

(30) Foreign Application Priority Data
Nov. 22, 2023 (CN) 202311570123.4

(51) Int. Cl. H01R 43/16; H01R 43/26

(52) U.S. Cl. CPC H01R 43/16; H01R 43/26

(57) ABSTRACT

A terminal strip splicing device includes a first cutting module and a second cutting module. The first cutting module is adapted to cut one end of a first terminal strip to form a joint slot on one end of the first terminal strip. The second cutting module is adapted to cut one end of the second terminal strip to form a joint protrusion on one end of the second terminal strip. The joint protrusion of the second terminal strip is complementary to the joint slot of the first terminal strip and is adapted to be joined together, in order to splice the first terminal strip and the second terminal strip into a continuous terminal strip.

### CROSS-REFERENCE TO RELATED APPLICATION

This application claims the benefit of Chinese Patent Application No. CN202311570123.4 filed on Nov. 22, 2023 in the State Intellectual Property Office of China, the whole disclosure of which is incorporated herein by reference.

### FIELD OF THE DISCLOSURE

The present disclosure relates to a terminal strip splicing device and a terminal strip splicing method.

### BACKGROUND OF THE INVENTION

In the prior art, during the assembly of connectors, the terminals of the connectors are fed in the form of material strips. The last section of terminal strip in each roll is discarded due to insufficient length, resulting in a significant amount of waste.

### SUMMARY OF THE INVENTION

According to an embodiment of the present disclosure, a terminal strip splicing device includes a first cutting module and a second cutting module. The first cutting module is adapted to cut one end of a first terminal strip to form a joint slot on one end of the first terminal strip. The second cutting module is adapted to cut one end of the second terminal strip to form a joint protrusion on one end of the second terminal strip. The joint protrusion of the second terminal strip is complementary to the joint slot of the first terminal strip and is adapted to be joined together, in order to splice the first terminal strip and the second terminal strip into a continuous terminal strip.

### BRIEF DESCRIPTION OF DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a terminal strip splicing device according to an exemplary embodiment of the present invention;

FIG. 2 shows an illustrative perspective view of a terminal strip splicing device according to an exemplary embodiment of the present invention, in which two segments of terminal strips are spliced;

FIG. 3 shows an illustrative perspective view of the first cutting module of the terminal strip splicing device according to an exemplary embodiment of the present invention when viewed from one side;

FIG. 4 shows an illustrative perspective view of the first cutting module of the terminal strip splicing device according to an exemplary embodiment of the present invention when viewed from the other side;

FIG. 5 shows an illustrative perspective view of the second cutting module of the terminal strip splicing device according to an exemplary embodiment of the present invention when viewed from one side;

FIG. 6 shows an illustrative perspective view of the second cutting module of the terminal strip splicing device according to an exemplary embodiment of the present invention when viewed from the other side;

FIG. 7 shows an illustrative perspective view of the base of a terminal strip splicing device according to an exemplary embodiment of the present invention;

FIG. 8 shows an illustrative perspective view of the base of a terminal strip splicing device according to an exemplary embodiment of the present invention, wherein one end of two terminal strips being spliced is shown;

FIG. 9 shows an illustrative view of one end of two terminal strips that have been cut according to an exemplary embodiment of the present invention;

FIG. 10 shows an illustrative view of two terminal strips with their cut ends spliced together according to an exemplary embodiment of the present invention;

FIG. 11 shows an illustrative view of two terminal strips according to an exemplary embodiment of the present invention;

FIG. 12 shows an illustrative view of two terminal strips after being cut according to an exemplary embodiment of the present invention; and

FIG. 13 shows an illustrative view of two terminal strips spliced together according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an exemplary embodiment of the present disclosure, a terminal strip splicing device includes: a first cutting module which is used to cut one end of a first terminal strip to form a joint slot on one end of the first terminal strip; and a second cutting module which is used to cut one end of the second terminal strip to form a joint protrusion on one end of the second terminal strip. The joint protrusion of the second terminal strip is complementary to the joint slot of the first terminal strip and is adapted to be joined together, in order to splice the first terminal strip and the second terminal strip into a continuous terminal strip.

According to another exemplary embodiment of the present disclosure, there is provided a terminal strip splicing method comprising the following steps of: providing the above terminal strip splicing device; using the first cutting module to cut a joint slot on one end of the first terminal strip, and using the second cutting module to cut a joint protrusion on one end of the second terminal strip; and connecting the joint slot on one end of the first terminal strip with the joint protrusion on one end of the second terminal strip to splice the first terminal strip and the second terminal strip into a continuous terminal strip.

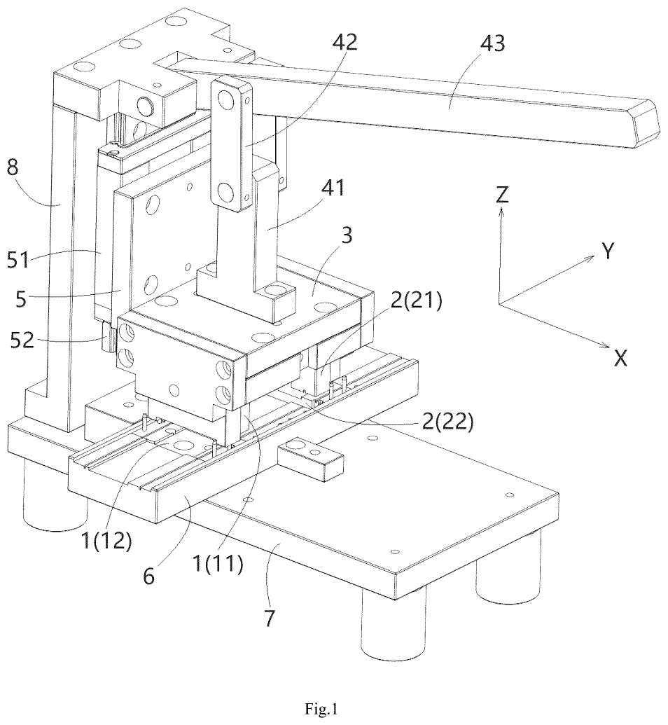

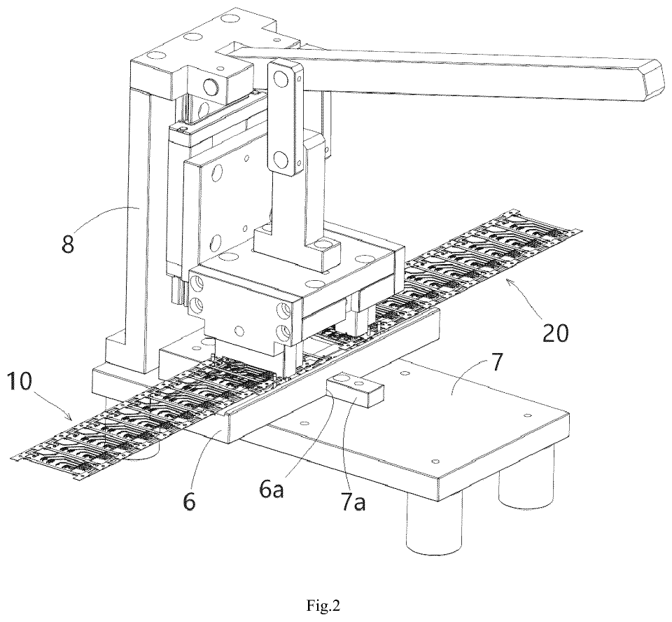

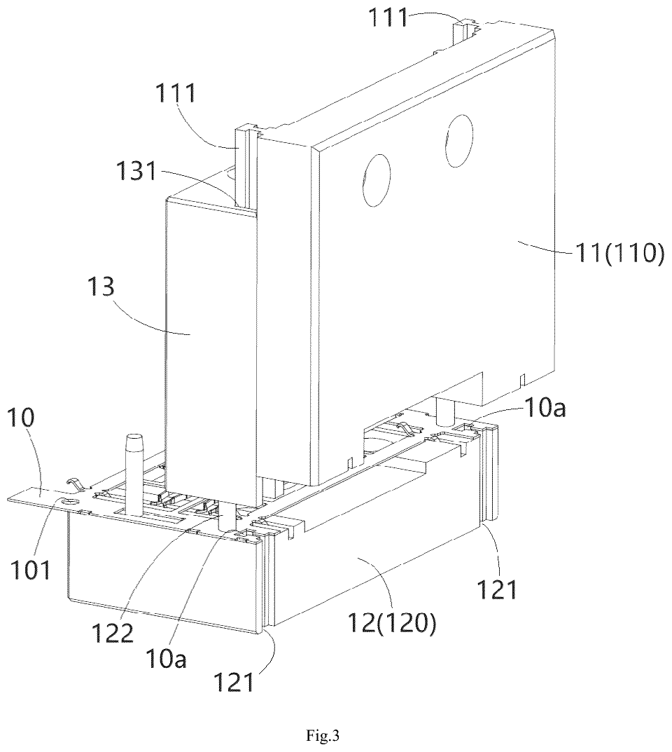

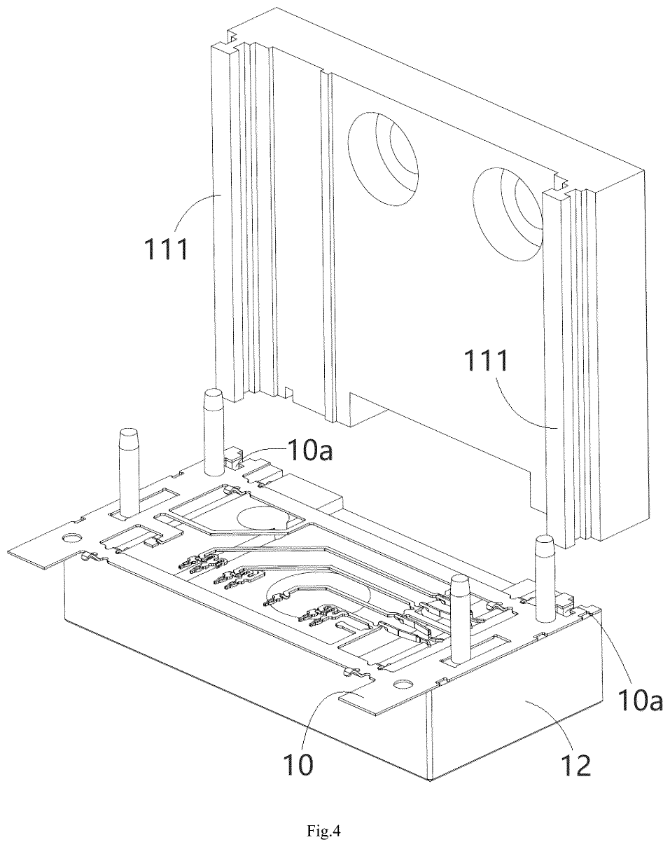

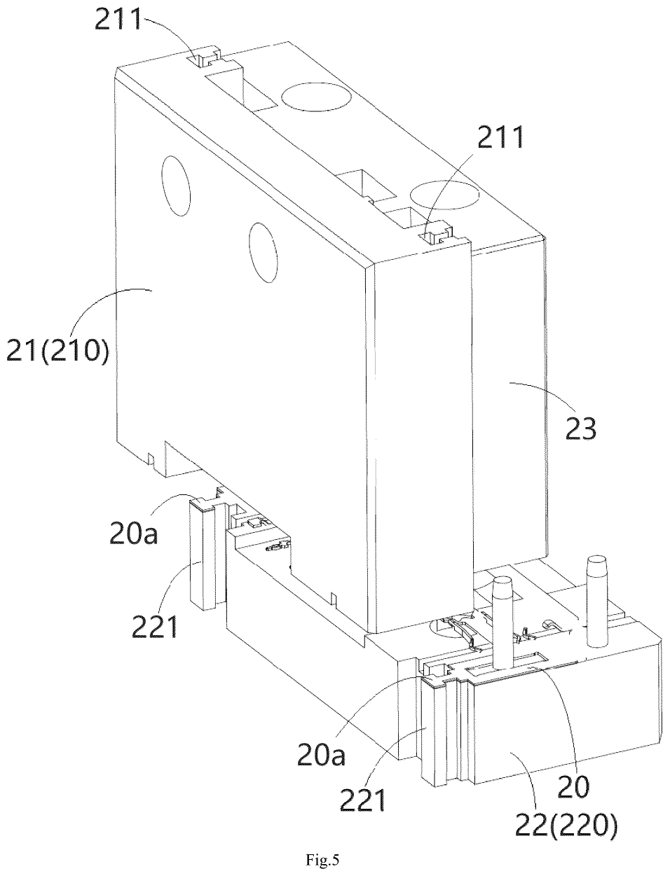

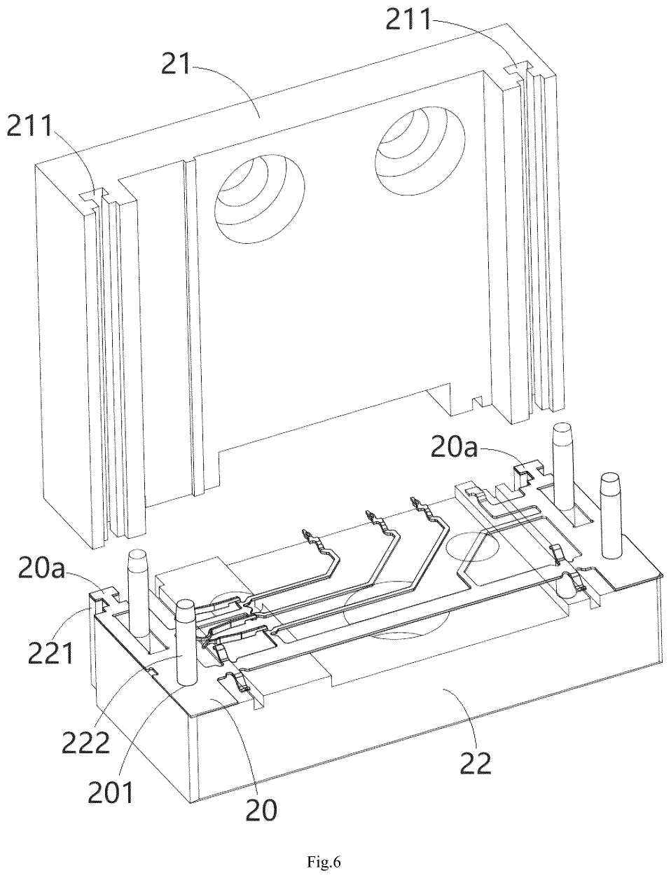

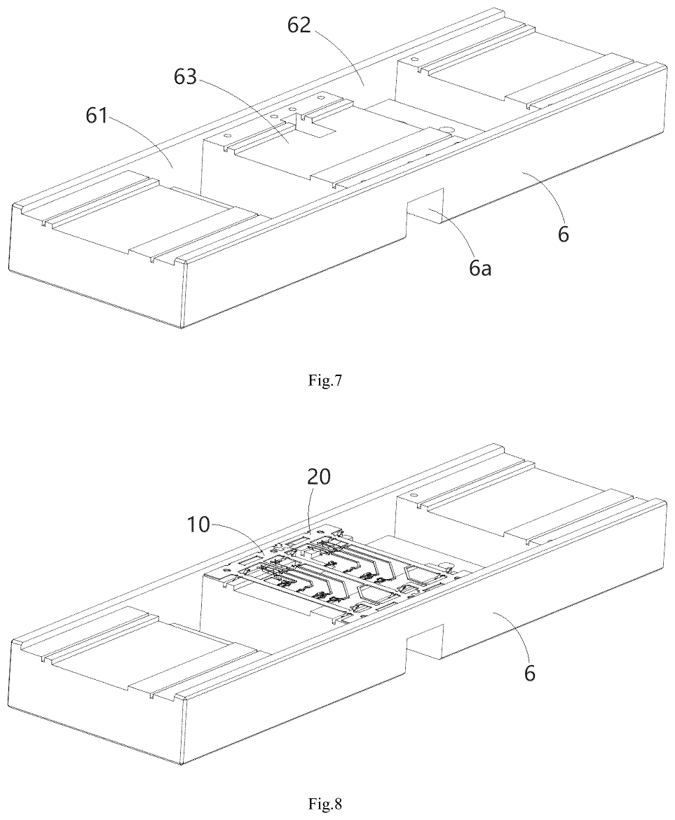

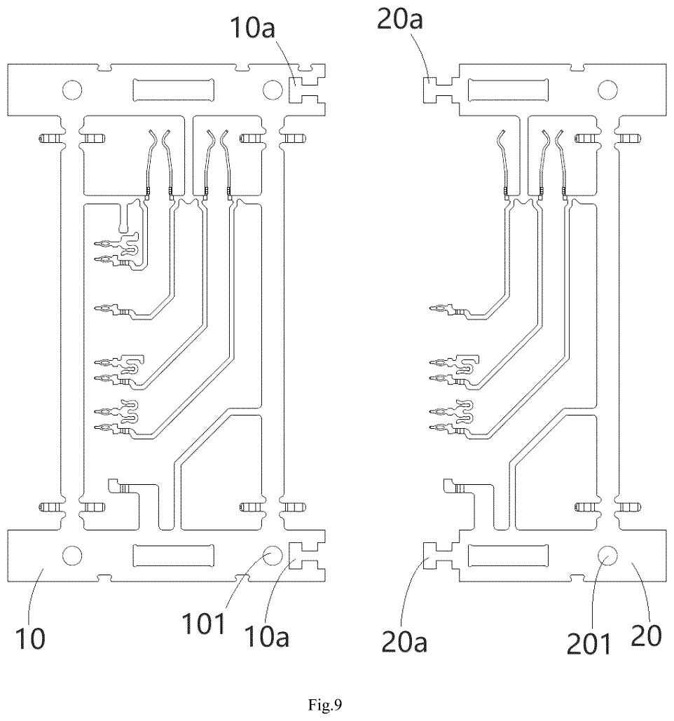

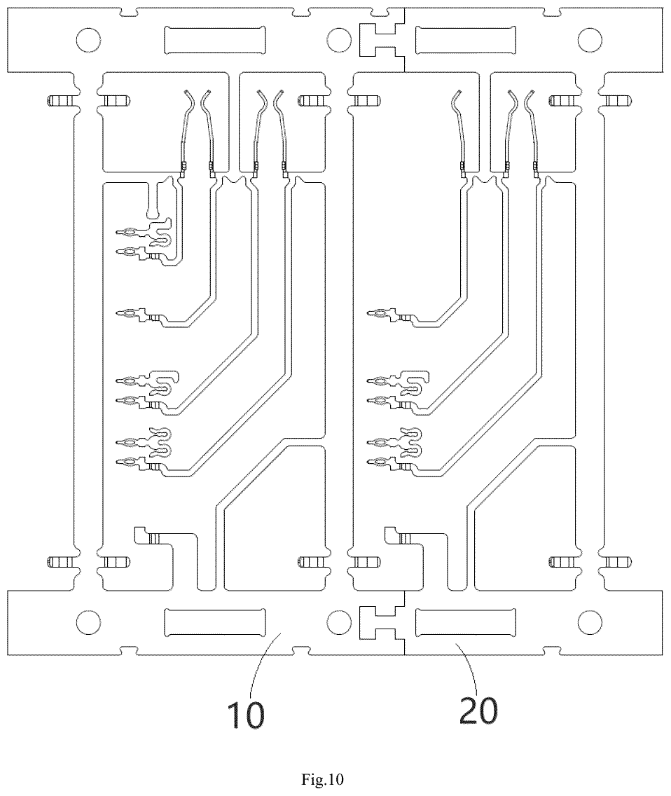

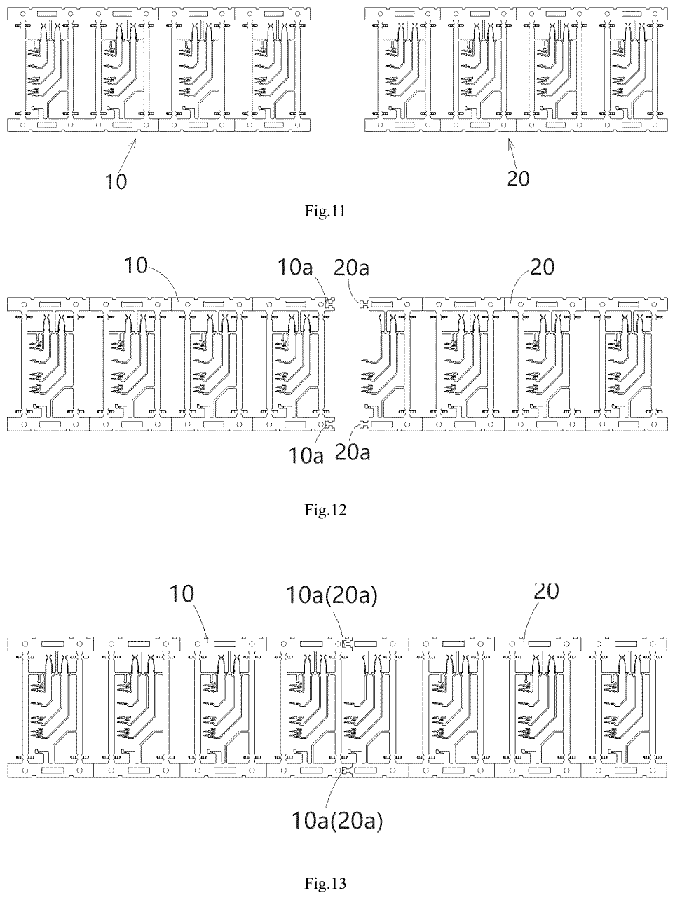

FIG. 1 shows an illustrative perspective view of a terminal strip splicing device according to an exemplary embodiment of the present invention. FIG. 2 shows an illustrative perspective view of a terminal strip splicing device according to an exemplary embodiment of the present invention, in which two segments of terminal strips 10 and 20 are spliced. FIG. 3 shows an illustrative perspective view of the first cutting module of the terminal strip splicing device according to an exemplary embodiment of the present invention when viewed from one side. FIG. 4 shows an illustrative perspective view of the first cutting module of the terminal strip splicing device according to an exemplary embodiment of the present invention when viewed from the other side. FIG. 5 shows an illustrative perspective view of the second cutting module of the terminal strip splicing device according to an exemplary embodiment of the present invention when viewed from one side. FIG. 6 shows an illustrative perspective view of the second cutting module of the terminal strip splicing device according to an exemplary embodiment of the present invention when viewed from the other side. FIG. 7 shows an illustrative perspective view of the base 6 of the terminal strip splicing device according to an exemplary embodiment of the present invention. FIG. 8 shows an illustrative perspective view of the base of a terminal strip splicing device according to an exemplary embodiment of the present invention, wherein the spliced ends of two terminal strips 10 and 20 are shown. FIG. 9 shows an illustrative view of one end of two terminal strips 10, 20 that have been cut according to an exemplary embodiment of the present invention. FIG. 10 shows an illustrative view of two terminal strips 10, 20 with their cut ends spliced together according to an exemplary embodiment of the present invention. FIG. 11 shows an illustrative view of two terminal strips 10, 20 according to an exemplary embodiment of the present invention. FIG. 12 shows an illustrative view of two terminal strips 10, 20 after being cut according to an exemplary embodiment of the present invention. FIG. 13 shows an illustrative view of two terminal strips 10, 20 spliced together according to an exemplary embodiment of the present invention.

As shown in FIGS. 1-13, in an exemplary embodiment of the present disclosure, a terminal strip splicing device is disclosed. The terminal strip splicing device includes a first cutting module 11, 12, 13 and a second cutting module 21, 22, 23. The first cutting module 11, 12, 13 is used to cut one end of the first terminal strip 10 to form a joint slot 10a on one end of the first terminal strip 10. The second cutting module 21, 22, 23 is used to cut one end of the second terminal strip 20 to form a joint protrusion 20a on one end of the second terminal strip 20. The joint protrusion 20a of the second terminal strip 20 is complementary to the joint slot 10a of the first terminal strip 10 and adapted to be joined together, in order to splice the first terminal strip 10 and the second terminal strip 20 into a continuous terminal strip.

In the illustrated embodiment, the first cutting module 11, 12, 13 includes a first upper cutting mold 11 and a first lower cutting mold 12. The first upper cutting mold 11 has a first rib 111 extending along a vertical direction Z. The first cutting mold 12 has a first groove 121 extending along the vertical direction Z. The first rib 111 and the first groove 121 cooperate with each other to cut out a joint slot 10a on one end of the first terminal strip 10.

The first lower cutting mold 12 is fixed and stationary, while the first upper cutting mold 11 can move in the vertical direction Z relative to the first lower cutting mold 12. During the cutting process, one end of the first terminal strip 10 is supported and positioned on the top surface of the first lower cutting mold 12.

The first lower cutting mold 12 includes a first lower block 120 and a first positioning pin 122. The first groove 121 is formed on the first lower block 120, and the first positioning pin 122 is fixedly provided on the first lower block 120. The first positioning pin 122 extends vertically upward from the top surface of the first lower block 120, and is used to insert into a first positioning hole 101 formed in one end of the first terminal strip 10 to position the first terminal strip 10 at a first cutting position.

The first upper cutting mold 11 includes a first upper block 110, and the first rib 111 is formed on one side of the first upper block 110. The first cutting module 11, 12, 13 also includes a first guide block 13, which is fixed and formed with a guide groove 131 that cooperates with the first rib 111 to guide the first upper cutting mold 11 to move in the vertical direction. The first guide block 13 can be fixed to the bracket 8, for example.

The second cutting module 21, 22, 23 includes a second upper cutting mold 21 and a second lower cutting mold 22. The second upper cutting mold 21 has a second groove 211 extending along the vertical direction Z. The second cutting mold 22 has a second rib 221 extending along the vertical direction Z. The second rib 221 and the second groove 211 cooperate with each other to cut out a joint protrusion 20a on one end of the second terminal strip 20.

The second lower cutting mold 22 is fixed and stationary, while the second upper cutting mold 21 can move in the vertical direction Z relative to the second lower cutting mold 22. During the cutting process, one end of the second terminal strip 20 is supported and positioned on the top surface of the second lower cutting mold 22.

The second lower cutting mold 22 includes a second lower block 220 and a second positioning pin 222. The second rib 221 is formed on the second lower block 220, and the second positioning pin 222 is fixedly provided on the second lower block 220. The second positioning pin 222 extends vertically upward from the top surface of the second lower block 220, and is used to insert into a second positioning hole 201 formed in one end of the second terminal strip 20 to position the second terminal strip 20 at a second cutting position.

The second upper cutting mold 21 includes a second upper block 210, and the second groove 211 is formed on one side of the second upper block 210. The second cutting module 21, 22, 23 also includes a second guide block 23, which is fixed and formed with a guide rib 231 that cooperates with the second groove 211 to guide the second upper cutting mold 21 to move in the vertical direction. The second guide block 23 can be fixed to the bracket 8.

The terminal strip splicing device further comprises a base 6, which is formed with a first positioning slot 61 and a second positioning slot 62. The first lower cutting mold 12 is installed and positioned in the first positioning slot 61 of the base 6, and the second lower cutting mold 22 is installed and positioned in the second positioning slot 62 of the base 6.

The base 6 has a splicing part 63 located between the first positioning slot 61 and the second positioning slot 62. The cut ends of the first terminal strip 10 and the second terminal strip 20 are adapted to be positioned in the splicing part 63 of the base 6 and joined together.

The terminal strip splicing device further comprises a seat 7, and the base 6 is fixed on the top surface of the seat 7. A positioning block 7a extending along the first horizontal direction X is provided on the top surface of the seat 7, and a positioning slot 6a cooperating with the positioning block 7a is formed on the bottom surface of the base 6.

In the illustrated embodiment, the terminal strip splicing device further comprises a bracket 8 and a pressing mechanism. The bracket 8 is fixed to the seat 7. The pressing mechanism is installed on the bracket 8 to drive the first upper cutting mold 11 and the second upper cutting mold 21 to move in the vertical direction Z.

The pressing mechanism includes a pressing plate 3 and a mounting plate 5. The first upper cutting mold 11 and the second upper cutting mold 21 are fixed to the bottom surface of the pressing plate 3. The mounting plate 5 is mounted on the bracket 8 in a movable manner and can move along the vertical direction Z. One side of the pressing plate 3 is fixed to the mounting plate 5 so as to be able to move along the vertical direction Z together with the mounting plate 5. The pressing plate 3 is used to drive the first upper cutting mold 11 and the second upper cutting mold 21 to move synchronously in the vertical direction Z.

A slide rail 52 extending along the vertical direction Z is provided on the bracket 8, and a slider 51 is fixed on the mounting plate 5. The slider 51 cooperates with the slide rail 52 to guide the mounting plate 5 to move along the vertical direction Z.

The pressing mechanism further includes a first connecting rod 41, a second connecting rod 42, and a pressing rod 43. The lower end of the first connecting rod 41 is fixed to the top surface of the pressing plate 3. The lower end of the second connecting rod 42 is rotatably connected to the upper end of the first connecting rod 41. One end of the pressing rod 43 is rotatably connected to the bracket 8. The upper end of the second connecting rod 42 is rotatably connected to the pressing rod 43 and adjacent to one end of the pressing rod 43, so that the pressing plate 3 can be driven to move in the vertical direction Z by pressing the other end of the aforementioned pressing rod 43.

The second connecting rod 42 can rotate about a first axis relative to the first connecting rod 41, the second connecting rod 42 can rotate about a second axis relative to the pressing rod 43, and the pressing rod 43 can rotate about a third axis relative to the bracket 8; And the aforementioned first axis, second axis, and third axis are parallel to each other and extend along a second horizontal direction Y perpendicular to the first horizontal direction X.

The joint slot 10a and the joint protrusion 20a are T-shaped, so that the first terminal strip 10 and the second terminal strip 20 that are spliced together cannot be separated in the horizontal direction (i.e., the extension direction of the terminal strip). However, the present invention is not limited to this, for example, the shapes of the joint slot 10a and the joint protrusion 20a may also be dovetail shaped or other suitable shapes.

In another exemplary embodiment of the present invention, a terminal strip splicing method is also disclosed. The terminal strip splicing method includes the following steps of:
S10: Providing the aforementioned terminal strip splicing device;
S20: Using the first cutting module 11, 12, 13 to cut a joint slot 10a on one end of the first terminal strip 10, and using the second cutting module 21, 22, 23 to cut a joint protrusion 20a on one end of the second terminal strip 20; and
S30: Connecting the joint slot 10a on one end of the first terminal strip 10 with the joint protrusion 20a on one end of the second terminal strip 20, to splice the first terminal strip 10 and the second terminal strip 20 into a continuous terminal strip.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal strip splicing device, comprising:
a first cutting module adapted to cut one end of a first terminal strip to form a joint slot on one end of the first terminal strip; and
a second cutting module adapted to cut one end of the second terminal strip to form a joint protrusion on one end of the second terminal strip, the joint protrusion of the second terminal strip is complementary to the joint slot of the first terminal strip and is adapted to be joined together, in order to splice the first terminal strip and the second terminal strip into a continuous terminal strip.

2. The terminal strip splicing device according to claim 1, wherein the first cutting module comprises:
a first upper cutting mold having a first rib extending along a vertical direction; and
a first lower cutting mold having a first groove extending along the vertical direction, the first rib and the first groove cooperate with each other to cut out the joint slot on one end of the first terminal strip.

3. The terminal strip splicing device according to claim 2, wherein:
the first lower cutting mold is fixed, the first upper cutting mold is movable in the vertical direction relative to the first lower cutting mold; and
during the cutting process, one end of the first terminal strip is supported and positioned on a top surface of the first lower cutting mold.

4. The terminal strip splicing device according to claim 3, wherein:
the first lower cutting mold comprises a first lower block and a first positioning pin, wherein the first groove is formed on the first lower block, and the first positioning pin is fixedly provided on the first lower block; and
the first positioning pin extends vertically upward from the top surface of the first lower block and is used to insert into a first positioning hole formed in one end of the first terminal strip to position the first terminal strip at a first cutting position.

5. The terminal strip splicing device according to claim 3,
the first upper cutting mold comprises a first upper block, and the first rib is formed on one side of the first upper block;
the first cutting module further includes a first guide block fixed and formed with a guide groove that cooperates with the first rib to guide the first upper cutting mold to move in the vertical direction.

6. The terminal strip splicing device according to claim 2, wherein the second cutting module comprises:
a second upper cutting mold having a second groove extending along the vertical direction; and
a second lower cutting mold having a second rib extending along the vertical direction, the second rib and the second groove cooperate with each other to cut out the joint protrusion on one end of the second terminal strip.

7. The terminal strip splicing device according to claim 6, wherein:
the second lower cutting mold is fixed, and the second upper cutting mold is movable in the vertical direction relative to the second lower cutting mold;
during the cutting process, one end of the second terminal strip is supported and positioned on the top surface of the second lower cutting mold.

8. The terminal strip splicing device according to claim 7, wherein:
the second lower cutting mold comprises a second lower block and a second positioning pin, wherein the second rib is formed on the second lower block, and the second positioning pin is fixedly provided on the second lower block; and
the second positioning pin extends vertically upward from the top surface of the second lower block and is inserted into a second positioning hole formed in one end of the second terminal strip to position the second terminal strip at a second cutting position.

9. The terminal strip splicing device according to claim 7, wherein:
the second upper cutting mold comprises a second upper block, and the second groove is formed on one side of the second upper block; and
the second cutting module further comprises a second guide block fixed and formed with a guide rib that cooperates with the second groove to guide the second upper cutting mold to move in the vertical direction.

10. The terminal strip splicing device according to claim 6, further comprising a base formed with a first positioning slot and a second positioning slot, the first lower cutting mold is installed and positioned in the first positioning slot of the base, the second lower cutting mold is installed and positioned in the second positioning slot of the base.

11. The terminal strip splicing device according to claim 10, wherein the base has a splicing part located between the first positioning slot and the second positioning slot, and the cut ends of the first terminal strip and the second terminal strip are adapted to be positioned in the splicing part of the base and joined together.

12. The terminal strip splicing device according to claim 11, further comprising a seat, wherein:
the base is fixed on the top surface of the seat;
a positioning block extending along a first horizontal direction is provided on the top surface of the seat; and
a positioning slot cooperating with the positioning block is formed on the bottom surface of the base.

13. The terminal strip splicing device according to claim 12, further comprising:
a bracket fixed to the seat; and
a pressing mechanism installed on the bracket and driving the first upper cutting mold and the second upper cutting mold to move in the vertical direction.

14. The terminal strip splicing device according to claim 13, wherein the pressing mechanism comprises:
a pressing plate, wherein the first upper cutting mold and the second upper cutting mold are fixed to the bottom surface of the pressing plate; and
a mounting plate mounted on the bracket in a movable manner and can be moved along the vertical direction, one side of the pressing plate is fixed to the mounting plate so as to be able to move along the vertical direction together with the mounting plate, and the pressing plate is adapted to drive the first upper cutting mold and the second upper cutting mold to move synchronously in the vertical direction.

15. The terminal strip splicing device according to claim 14, wherein a slide rail extending in the vertical direction is provided on the bracket, and a slider is fixed on the mounting plate, the slider cooperates with the slide rail to guide the mounting plate to move in the vertical direction.

16. The terminal strip splicing device according to claim 15, wherein the pressing mechanism further comprises:
a first connecting rod, a lower end of which is fixed to the top surface of the pressing plate;
a second connecting rod, a lower end of which is rotatably connected to an upper end of the first connecting rod; and
a pressing rod, one end of which is rotatably connected to the bracket, the upper end of the second connecting rod is rotatably connected to the pressing rod and adjacent to one end of the pressing rod and adapted to drive the pressing plate to move in the vertical direction by pressing the other end of the pressing rod.

17. The terminal strip splicing device according to claim 16, wherein the second connecting rod is rotatable about a first axis relative to the first connecting rod, the second connecting rod is rotatable about a second axis relative to the pressing rod, and the pressing rod is rotatable about a third axis relative to the bracket.

18. The terminal strip splicing device according to claim 17, wherein the first axis, the second axis, and the third axis are parallel to each other and extend along a second horizontal direction perpendicular to the first horizontal direction.

19. The terminal strip splicing device according to claim 1, wherein the joint slot and the joint protrusion are T-shaped or dovetail shaped, such that the first terminal strip and the second terminal strip that are spliced together cannot be separated in the horizontal direction.

20. A terminal strip splicing method comprising the steps of:
providing the terminal strip splicing device according to claim 1;
using the first cutting module to cut a joint slot on one end of the first terminal strip, and using the second cutting module to cut a joint protrusion on one end of the second terminal strip; and
connecting the joint slot on one end of the first terminal strip with the joint protrusion on one end of the second terminal strip to splice the first terminal strip and the second terminal strip into a continuous terminal strip.
